(19) United States
(12) Patent Application Publication
(10) Pub. No.: US 2016/0135928 A1
(43) Pub. Date: May 19, 2016

(54) INTERARCH FORCE MODULE WITH LINK FOR ORTHODONTIC TREATMENT

(71) Applicant: 3M INNOVATIVE PROPERTIES COMPANY, St. Paul, MN (US)

(72) Inventor: James D. Cleary, Glendora, CA (US)

(21) Appl. No.: 15/006,461

(22) Filed: Jan. 26, 2016

Related U.S. Application Data
(63) Continuation of application No. 13/263,685, filed on Oct. 7, 2011.
(60) Provisional application No. 61/168,946, filed on Apr. 14, 2009.

(51) Int. Cl. A61C 7/22; A61C 7/14

(52) U.S. Cl. CPC A61C 7/22; A61C 7/14

(57) ABSTRACT

A force module is interconnected between upper and lower dental arches of an orthodontic patient in order to move the positions of the arches relative to each other. The force module includes at least two sliding members that move relative to each other along with a link for connecting one of the sliding members to one of the dental arches. The link is pivotally movable about two spaced apart, parallel reference axes that are generally perpendicular to the axis of sliding movement of the members. The link enables the force module to be readily shifted in a lingual direction as the patient's jaws are closed.

### CROSS REFERENCE TO RELATED APPLICATIONS

This application is continuation application of U.S. patent application Ser. No. 13/263,685, filed Oct. 7, 2011, which is a national stage filing under 35 U.S.C. 371 of PCT/US2010/030802, filed Apr. 13, 2010, which claims priority to U.S. Provisional Application No. 61/168,946, filed Apr. 14, 2009, the disclosures of which are incorporated by reference in their entirety herein.

### BACKGROUND OF THE INVENTION

1. Field of the Invention

This invention relates to apparatus useful during orthodontic treatment for correcting the position of one dental arch relative to the other. More specifically, the present invention relates to an orthodontic force module for urging one of the dental arches either in a forward or a rearward direction relative to the other dental arch in order to improve occlusion.

2. Description of the Related Art

Orthodontic treatment involves movement of malpositioned teeth to orthodontically correct locations. Orthodontic treatment can improve the patient's occlusion so that the teeth of one jaw function in a satisfactory manner in cooperation with the teeth of the opposite jaw. In addition, teeth that are straightened by orthodontic treatment can significantly improve a patient's facial appearance.

One type of orthodontic treatment includes the use of a system of tiny appliances known as brackets. The brackets are connected to anterior, cuspid and bicuspid teeth, and an archwire is placed in a slot of each bracket. The archwire forms a track to guide movement of the brackets and the associated teeth to desired positions for correct occlusion. Typically, the ends of the archwire are received in appliances known as buccal tube brackets that are secured to molar teeth.

The orthodontic treatment of some patients includes correction of the alignment of the upper dental arch with the lower dental arch. For example, certain patients have a condition referred to as a Class II malocclusion where the lower dental arch is located an excessive distance in a rearward direction relative to the location of the upper dental arch when the jaws are closed. Other patients may have an opposite condition referred to as a Class III malocclusion wherein the lower dental arch is located in a forward direction of its desired location relative to the position of the upper dental arch when the jaws are closed.

Orthodontic treatment of Class II and Class III malocclusions are commonly corrected by movement of the upper dental arch as a single unit relative to the movement of the lower dental arch as a single unit. To this end, forces are often applied to each dental arch as a unit by applying force to the brackets, the buccal tubes or the archwires, or attachment devices connected to the brackets, buccal tubes, or archwires. In this manner, a Class II or Class III malocclusion can be corrected at the same time that the archwires and the brackets are used to move individual teeth to desired positions relative to each other.

A number of force modules or appliances are known in the art for correcting Class II and Class III malocclusions. For example, the force modules described in U.S. Pat. No. 3,798,773 (Northcutt), U.S. Pat. No. 4,462,800 (Jones) and U.S. Pat. No. 4,551,095 (Mason) are constructed using telescoping tube assemblies that urge the dental arches toward positions of improved alignment. The telescoping tube assemblies are securely coupled to other orthodontic components in the oral cavity such as brackets, buccal tubes or archwires.

Another type of telescoping tube force module for repositioning the dental arches is described in U.S. Pat. No. 5,964,588 (Cleary). The force module described in this patent has a spring that urges telescoping members away from each other to achieve desired movement of the patient's teeth. Other patents that describe orthodontic telescoping tube assemblies with springs include U.S. Pat. No. 5,711,667 (Vogt) and U.S. Pat. No. 5,562,445 (DeVincenzo et al.).

The telescoping tube force module that is described in U.S. Pat. No. 5,964,588 has a connector on each end. In one embodiment described in this patent, an upper connector has a hole that receives a pin with a shank having a generally “L”-shaped configuration. The shank of the pin is of a size that is adapted to fit in the passage of a buccal tube, a headgear tube or other orthodontic appliance that is fixed to the upper dental arch. A lower connector includes a pair of opposed arms that are fixed to one of the telescoping members. The opposed arms of this connector are bendable toward each other to a closed position in order to connect the force module to an archwire, an auxiliary wire or another component that is secured to the patient's lower dental arch.

While the concepts described in U.S. Pat. No. 5,964,588 are generally satisfactory, there is a continuing need in the art for improvements that facilitate the installation, use and operation of the interarch appliance. Preferably, any such improvements would also increase the versatility of the appliance so that it can be adapted for use in a variety of different situations with different patients. Moreover, it is preferable that any such improvements do not increase the cost of the appliance or increase the likelihood that the patient will experience discomfort during the course of treatment.

### SUMMARY OF THE INVENTION

The present invention relates to an orthodontic interarch force module that includes an improved link for connecting the force module to a wire such as an archwire. The link enables the force module to freely pivot about two adjacent but different reference axes during opening and closing movements of the patient's jaws. As a result, the end of the force module adjacent the link remains in close proximity to the facial side of the patient's teeth and is less likely to cause discomfort by impinging upon nearby tissue in the patient's oral cavity.

In more detail, the present invention is directed in one embodiment to an intra-oral force module for moving the relative positions of the upper and lower dental arches. The force module comprises a first member having an outer end portion and a connector coupled to the outer end portion of the first member for connecting the first member to an orthodontic appliance. The force module also includes a second member connected to the first member and movable relative to the first member in directions along a reference axis. The second member includes an outer end portion that is remote from the outer end portion of the first member. The force module also includes a link connected to the outer end portion of the second member. The link is movable in an arc relative to the second member about a first axis that is generally perpendicular to the reference axis. The link includes a passage for receiving a wire and for enabling pivotal movement of the link relative to the wire about a second axis that is spaced from and generally parallel to the first axis.

Another aspect of the present invention is directed toward an orthodontic assembly. The assembly comprises a brace including a set of orthodontic appliances and a wire connected to the appliances. The assembly also comprises an intra-oral force module including a first member and a second member. The second member is connected to the first member for sliding movement relative to the first member in directions along a reference axis. The force module further includes a link connecting the second member to the wire. The link is pivotally movable relative to the wire about a first axis that is generally perpendicular to the reference axis. The link is also pivotally movable relative to the second member about a second axis that is spaced from and generally parallel to the first axis.

An additional aspect of the present invention is directed to an intra-oral force module that comprises a first member and a second member. The second member is connected to the first member for sliding movement relative to the first member in directions along a reference axis. The second member includes an outer end segment that extends in a direction generally perpendicular to the reference axis. The outer end portion includes a head. The force module further includes a link for connecting the second member to a wire. The link includes at least one aperture for receiving the outer end portion of the second member. The aperture normally presents an interference fit with the head. The link is comprised of an elastomeric material having a modulus of elasticity that is sufficient to enable the aperture to be enlarged and allow passage of the head through the aperture.

The present invention is directed in another aspect to a link for an intra-oral force module. The link comprises an elongated body made of an elastomeric material. The body includes a central strap portion with opposed first and second ends and first and second loop portions connected to the first and second ends respectively. The body also includes first and second tabs extending outwardly from the first and second loop portions respectively in directions away from each other.

The present invention is especially advantageous in instances when the force module is constructed with two or more members that slide relative to each other in telescoping fashion. Optionally, an external segment of the innermost telescoping member is bent in such a manner to generally follow the shape of the curvature of the patient's dental arch. The bent member, in combination with the link, enables the force module to be in close proximity to the patient's teeth even though the link provides substantial freedom of movement.

These and other aspects of the invention will be described in the paragraphs that follow and are illustrated in the accompanying drawings.

### DEFINITIONS

As used herein:
“Mesial” means in a direction toward the center of the patient's curved dental arch.
“Distal” means in a direction away from the center of the patient's curved dental arch.
“Occlusal” means in a direction toward the outer tips of the patient's teeth.
“Gingival” means in a direction toward the patient's gums or gingiva.
“Facial” means in a direction toward the patient's lips or cheeks.
“Lingual” means in a direction toward the patient's tongue.

### BRIEF DESCRIPTION OF THE DRAWINGS

FIG. 1 is a side elevational view of an exemplary upper and lower dental arch of a patient undergoing orthodontic treatment that includes use of an interarch force module constructed according to one embodiment of the present invention;

FIG. 2 is a fragmentary plan view of the dental arches and the force module shown in FIG. 1, except that some of the patient's upper teeth and associated orthodontic appliances have been omitted from the view for purposes of illustration;

FIG. 3 is a side cross-sectional view of the force module alone that is shown in FIGS. 1 and 2, looking in a lingual direction, except that a link of the force module has been pivoted from its orientation shown in FIGS. 1 and 2;

FIG. 4 is a top view of one of the sliding members of the force module illustrated in FIGS. 1-3;

FIG. 5 is a plan view of a link of the force module shown in FIGS. 1-3, depicting the link as it initially appears before installation in the patient's mouth and before connection to remaining components of the force module;

FIG. 6 is a side elevational view of the link shown in FIG. 5;

FIG. 7 is a fragmentary plan view of an end portion of a link and one of the movable members of an intra-arch force module according to another embodiment of the invention, and looking in a facial direction;

FIG. 8 is a reduced bottom view of the force module member illustrated in FIG. 7, except that the position of the link has been changed from its position shown in FIG. 7;

FIG. 9 is a side elevational view of another exemplary upper and lower dental arch of a patient undergoing orthodontic treatment along with a force module that is constructed in accordance with an additional embodiment of the invention;

FIG. 10 is an enlarged plan view of one of the movable members of the force module illustrated in FIG. 9 along with a link of the force module;

FIG. 11 is a side elevational view of the force module member alone that is illustrated in FIG. 10;

FIG. 12 is an enlarged plan view of a force module member according to yet another embodiment of the invention;

FIG. 13 is a side elevational view of the member shown in FIG. 12;

FIG. 14 is a side elevational view of a link of a force module that is constructed in accordance with an alternative embodiment of the present invention, illustrating the link in its initially open orientation;

FIG. 15 is an end elevational view of the link shown in FIG. 14;

FIG. 16 is a side elevational view of another link that is constructed in accordance with another embodiment of the present invention;

FIG. 17 is an end elevational view of the link shown in FIG. 16;

FIG. 18 is a side elevational view of a link constructed according to still another embodiment of the invention;

FIG. 19 is an end elevational view of the link shown in FIG. 18;

FIG. 20 is a side elevational view of a link that is constructed in accordance with yet another embodiment of the present invention; and

FIG. 21 is an end elevational view of the link shown in FIG. 20.

### DETAILED DESCRIPTION OF THE PREFERRED EMBODIMENTS

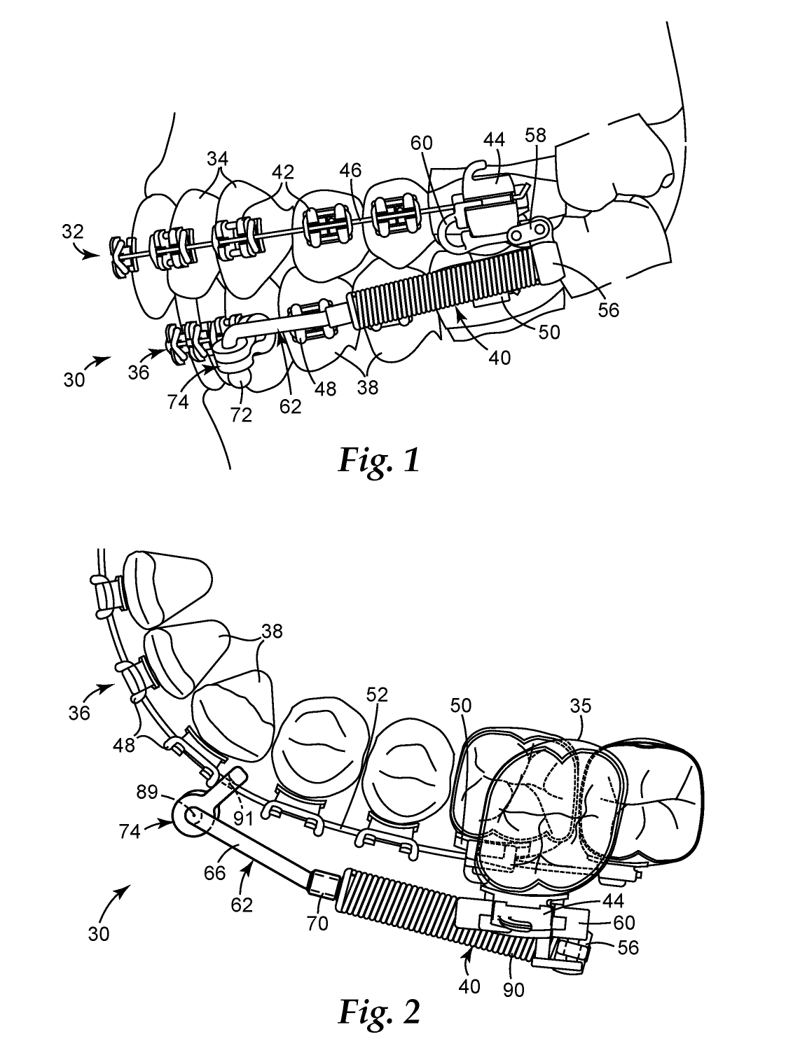

An orthodontic assembly 30 constructed in accordance with one embodiment of the present invention is depicted in FIGS. 1 and 2 along with exemplary oral structures of a patient undergoing orthodontic treatment. As shown in FIG. 1, an upper brace 32 is connected to upper teeth 34 of the patient's upper dental arch and a lower brace 36 is connected to lower teeth 38 of the patient's lower dental arch. An intra-oral force module, broadly designated by the numeral 40, is connected to both the upper brace 32 and the lower brace 36 for moving the relative positions of the upper and lower dental arches.

As illustrated in FIG. 1, the upper brace 32 includes a number of upper bracket appliances 42 that are affixed to the non-molar teeth of the upper dental arch. The upper brace 32 also includes an upper buccal tube appliance 44 that is affixed to a first molar tooth of the upper dental arch. In this exemplary illustration, the upper bracket appliances 42 are directly bonded to the enamel surfaces of the patient's teeth 34, while the upper buccal tube appliance 44 is brazed or welded to a band that encircles the patient's molar tooth 35. An elongated, resilient upper archwire 46 is received in the slots of the upper bracket appliances 42 and in a passage of the upper buccal tube appliance 44. The upper archwire 46 has a “U”-shaped configuration in plan view when relaxed that optionally extends along a curve corresponding to the desired curvature of the patient's upper dental arch at the conclusion of treatment. Optionally, and as shown in FIG. 1, an end portion of the upper archwire 46 that is located in a distal direction relative to the upper buccal tube appliance 44 is bent so that all of the teeth of the upper dental arch are urged in a distal direction when a force is applied to the upper buccal tube 44 in a distal direction.

Similarly, the lower brace 36 includes a number of lower bracket appliances 48 that are affixed to the non-molar lower teeth 38 of a patient's lower dental arch. The lower brace 36 further includes a lower buccal tube appliance 50 (partially hidden in the drawings) that is connected to a first molar tooth of the patient's lower dental arch. In this exemplary illustration, the lower bracket appliances 48 are directly bonded to the surfaces of the patient's lower teeth 38, while the lower buccal tube appliance 50 is welded or brazed to a band that is placed over the patient's lower first molar tooth in encircling relation. A lower archwire 52 extends through slots of the lower bracket appliances 48 and through a passage of the lower buccal tube appliance 50. The lower archwire 52 is somewhat similar to the upper archwire 46 in that the lower archwire 52 has a generally “U”-shaped configuration in plan view and optionally has a curvature when relaxed that generally corresponds to the desired curvature of the patient's lower dental arch at the conclusion of treatment.

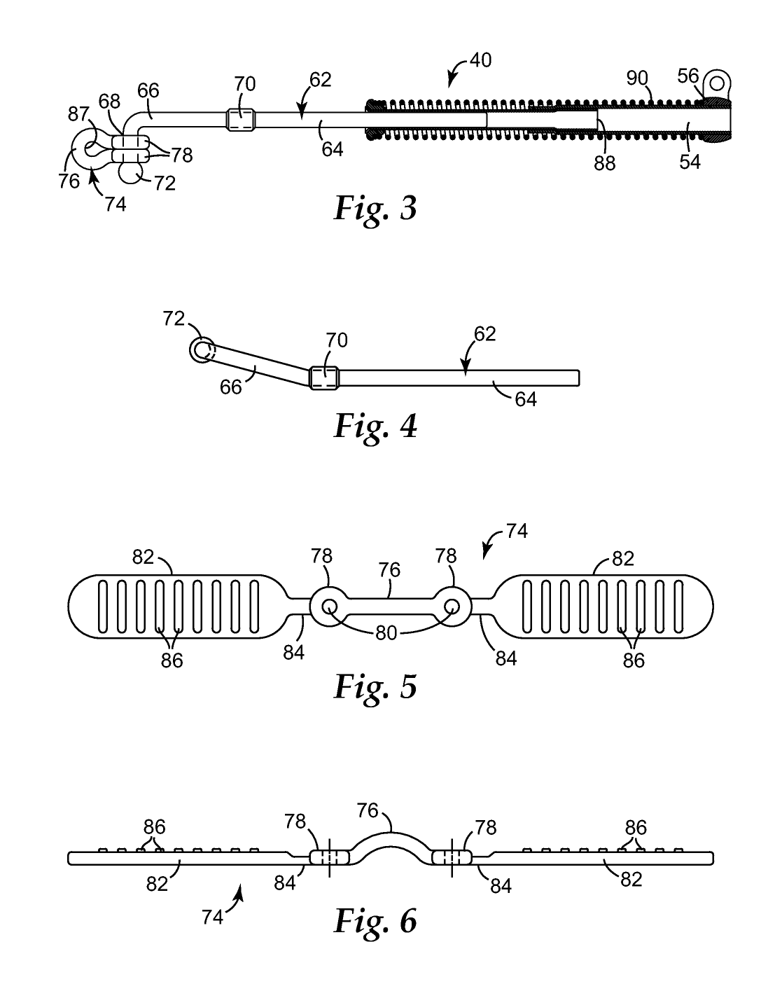

The force module 40 of the orthodontic assembly 30 is interconnected between the upper brace 32 and the lower brace 36 and is operable to move the relative positions of the upper and lower dental arches relative to each other. A cross-sectional view of the force module 40 is set out in FIG. 3. The force module 40 includes a rigid, hollow first member 54 having a tubular, elongated shape. An outer end portion of the first member 54 includes an end cap 56 with an outwardly extending tab that has a circular opening.

A connector 60 (see FIGS. 1 and 2) includes a first post that extends through the opening of the end cap 56. The first post is pivotally movable in the opening and enables pivotal movement of the connector 60 relative to the force module 40 in an arc about a facial-lingual reference axis. The connector 60 also includes a second post that is spaced from and parallel to the first post. A flat, oval-shaped plate 58 is welded to the outer ends of both posts and serves to retain the connector 60 in secure, coupled relationship to the end cap 56. As an alternative to the two posts and the plate 58, a linkage such as described in applicant's pending U.S. Patent Application entitled “ORTHODONTIC LINKAGE PROVIDING CONTROLLED PIVOTAL MOVEMENT”, Ser. No. 61/168,960 [attorney docket no. 65328U5002] and filed on Apr. 14, 2009.

Preferably, the connector 60 includes at least one resilient portion that enables the connector 60 to couple to the upper buccal tube appliance 44 in a “snap-fit” relationship. This “snap-fit” relationship is similar to the “snap-fit” relationship described in connection with the orthodontic attachment modules and couplings described in U.S. Pat. No. 6,913,460 (Cleary et al.) and U.S. Patent Application Publication No. 2009/0035715 (Cleary). The resilient portions hold the connector 60 in place and in captive relationship to the buccal tube appliance 44 during the course of treatment, but also enable the connector 60 to be disconnected from the buccal tube appliance 44 when desired.

Preferably, the connector 60 includes at least one rotation stop that helps limit undue rotational movement of the connector 60 and hence of the force module 40 about a reference axis extending in a generally mesial-distal direction. Preferably, the connector 60 includes two rotation stops that are movable relative to each other in order to facilitate placing the rotation stops in certain beneficial operative positions adjacent wall structures of the buccal tube appliance 44 for limiting undue rotational movements. Additional aspects and alternative constructions regarding the connector 60 are set out in the afore-mentioned U.S. Patent Application Publication No. 2009/0035715 (Cleary). As additional alternatives, the force module 40 may be coupled to the upper brace 32 by the connector described in applicant's pending U.S. Patent Application entitled “ORTHODONTIC CONNECTOR PROVIDING CONTROLLED ENGAGEMENT WITH AN ORTHODONTIC WIRE”, Ser. No. 61/168,959 [attorney docket no. 65198U5002], filed Apr. 14, 2009.

The force module 40 also includes a second member 62 that is shown alone in top view in FIG. 4. The second member 62 in this embodiment comprises a rigid, solid segment of cylindrical wire material that includes a first segment 64, a second segment 66 and an outer end segment or coupling segment 68. The second member 62 also includes a collar 70 that is fixed in place between the first segment 64 and the second segment 66, optionally by a brazing or welding operation. The collar 70 limits the extent of movement of the second member 60 in a direction toward the end cap 56.

As shown for example in FIGS. 2 and 4, the longitudinal axis of the first segment 64 extends at an angle relative to the longitudinal axis of the second segment 66 when viewed in directions perpendicular to an occlusal reference plane. This angle preferably varies in accordance with the overall length of the second member 62 in directions parallel to the longitudinal axis of the second member 62. As examples, if the overall length of the second member 62 (ignoring the head 72) is about 0.9 inch, the angle is about 65°; alternatively, if the overall length is about 1 inch, the angle is about 30°; and if the overall length is about 1.1 inch or greater, the angle is about 15°. However, and as can be appreciated by reference to FIGS. 1 and 3, the longitudinal axis of the first segment 64 and the longitudinal axis of the second segment 66 generally extend in a common reference plane that is parallel to an occlusal reference plane.

The coupling segment 68 extends at a non-zero angle relative to the longitudinal axis of the second segment 66 when viewed in directions parallel to an occlusal reference plane as depicted in FIG. 3. Preferably, this angle is in the range of about 70° to about 110°, and more preferably is about 90°. The coupling segment 68 normally extends in a gingival direction as shown for example in FIG. 1 when the force module 40 is connected in place to the upper and lower braces 32, 36.

An outermost, gingival end of the coupling segment 68 includes an enlarged spherical head 72. A link 74 is received on the coupling segment 68 for connection to the lower archwire 52 in an area between adjacent lower bracket appliances 48, 48. In this embodiment, the link 74 is comprised of an elastomeric material that is preferably resistant to staining when exposed to liquid and food in the oral cavity. Examples of suitable elastomeric materials include Texin 285 brand and Texin 390 brand polyurethane from Bayer Material Science AG. Other examples of suitable elastomeric materials are described in U.S. Pat. No. 5,461,133 (Hammar et al.).

Optionally, the link 74 has an initial shape when relaxed and before installation that appears as shown in FIGS. 5 and 6. The link 74 includes a central strap portion 76 with opposed first and second ends. The link 74 also includes first and second loop portions 78 are integrally connected to the first and second ends respectively of the strap portion 76. In plan view, the loop portions 78 and the strap portion 76 together present a somewhat “dogbone” configuration as shown in FIG. 5. Optionally, the central strap portion 76 when relaxed has a concave shape in side view as shown in FIG. 6 in order to facilitate placement of the link 74 about the lingual side of the lower archwire 52 when desired.

The link 74 initially includes structure for facilitating gripping the link 74 and for maneuvering the link 74 to its desired position. In the example shown in FIGS. 5 and 6, the link 74 initially includes first and second tabs 82 that are each integrally connected to outer sides of the first and second loop portions 78 respectively by a narrowed neck portion 84. As shown in FIGS. 5 and 6, the cross-sectional dimensions of the neck portions 84 are smaller than the corresponding cross-sectional dimensions of the adjacent tabs 82 and loop portions 78 when considered in directions perpendicular to the central, longitudinal axis of the link 74.

Preferably, the tabs 82 include structure for facilitating gripping of the link 74 during installation. In the example shown in the drawings, the structure comprises a series of spaced apart ribs 86 that extend in directions perpendicular to the longitudinal axis of the link 74. However, other structures for enhancing a grip are also possible, such as a series of bumps or grooves, cross-hatching or surfaces that have been roughened.

During installation of the force module 40 on the upper and lower braces 32, 36, the link 74 as it is shown in FIGS. 5 and 6 is manipulated such that one of the tabs 82 passes through the space between the lingual side of the lower archwire 52 and the adjacent teeth. Once the link 74 has been shifted to a position such that the concave strap portion 76 is adjacent the lingual side of the lower archwire 52, both tabs 82 are grasped and moved toward each other in order to bend the link 74 into a generally “U”-shaped configuration such that the strap portion 76 extends in a curve about the archwire 52 and presents a passage 87 (FIG. 3) for receiving the archwire 52. In addition, the tabs 82 are manipulated as needed in order to pass the head 72 of the second member 62 through the apertures 80 until the loop portions 78 are positioned on the coupling segment 68 and located in an occlusal direction relative to the head 72.

Next, the tabs 82 are detached from the respective loop portions 78 by fracturing, cutting or otherwise severing the neck portions 84. As one example, the practitioner may elect to gently urge both of the tabs 82 simultaneously in a facial direction while using a cutter, knife or other hand instrument to cut through the neck portions 84. The reduced cross-sectional area of the neck portions 84 facilitates detaching the tabs 82 from the loop portions 78 when desired.

The link 74, and particularly the loop portions 78, have sufficient resiliency to enable the apertures 80 to be somewhat enlarged without undue effort. As a consequence, when the loop portions 78 are pressed against the head 72, the loop portions 78 stretch and the apertures 80 are enlarged. The loop portions 78 can then pass over the head 72 and receive the region of the coupling segment 68 that extends between the head 72 and the second segment 66. Once the loop portions 78 are placed on the coupling segment 68 in this manner, the inherent resiliency of the loop portions 78 enables the latter to self-move and cause the apertures 80 to assume their normally smaller area when relaxed. The loop portions 78 are then retained in place on the coupling segment 68 due to the resultant interference fit relation between the apertures 80 and the head 72.

With reference again to FIG. 3, the force module 40 includes a sleeve 88 that is preferably made of a cylindrical section of tubular material. The sleeve 88 is partially received in the first member 54 in sliding, telescoping relation. The sleeve 88 is movable relative to the first member 54 from a fully compressed position as depicted in FIGS. 1 and 2 and to the fully extended position as shown in FIG. 3.

The sleeve 88 has an inner, enlarged end portion with an outer diameter that is larger than the outer diameter of the remaining extent of the sleeve 88. This inner end portion of the sleeve 88 has an outer diameter that is larger than the inner diameter of the end portion of the first member 54 remote from the end cap 56. As such, the inner end portion of the sleeve 88 functions as a stop to limit outward movement of the sleeve 88 relative to the first member 54 and also to prevent separation of the sleeve 88 from the first member 54.

The force module 40 also includes a helical compression spring 90 that extends externally around the first member 54 and the sleeve 88. An outer end of the spring 90 bears against the end cap 56 and an opposite end of the spring 90 is received in a circular recess of a connector that is fixed to an outer end portion of the sleeve 88. The spring 90 is illustrated in its nearly fully compressed position in FIGS. 1 and 2 and in its relaxed and fully extended position in FIG. 3.

The second member 62 is partially received in the sleeve 88 and is movable in telescopic fashion in a longitudinal direction along the central, longitudinal axis of the sleeve 88. Preferably, the second member 62 has an outer diameter that is slightly smaller than the inner diameter of the sleeve 88 in order to allow the second member 62 to slide freely in the sleeve 88. Preferably, the adjacent end of the second member 62 is flush with the outer end of the first member 54 adjacent the end cap 56 when the force module 40 is nearly fully compressed as shown in FIGS. 1 and 2 so that the second member 62 functions to push food debris or the like out of the end cap 56.

The collar 70 functions as a stop to limit movement of the second member 62 relative to the sleeve 88 in directions toward the end cap 56. In FIGS. 1 and 2, the second member 62 is illustrated as having reached a fully retracted position (i.e., it has reached its inward limit of travel in a direction toward the end cap 56). FIG. 3 is an example of an extended position of the second member 62 relative to the sleeve 88, although other extended positions are also possible.

As one example of use of the orthodontic assembly 30, the overall effective length of the force module 40 is selected so that the first member 54 and the sleeve 88 are almost but not fully compressed when the patient's jaws are closed. As shown in FIGS. 1 and 2, the force module 40 is in its nearly fully compressed configuration when the patient's jaws are closed. In this nearly fully compressed configuration, the collar 70 is in abutting relationship with the connector secured to the outer end of the sleeve 88 and the spring 90 is almost but not fully compressed. The inherent bias of the spring 90 provides the desired corrective forces by urging the first member 54 and the sleeve 88 in directions away from each other to thereby move one dental arch relative to the other.

The overall length of the force module 40 may be altered either by modifying the overall length of the second member 62 or by modifying the position of the collar 70 in order to change the length of the second segment 66. Optionally, the manufacturer of the force module 40 may make a number of second members 60 commercially available in different effective lengths so that the practitioner can select the best length for the particular patient undergoing treatment. Other aspects of the force module 40 along with alternative constructions and methods of use are set out in U.S. Pat. No. 5,964,588 (Cleary) except as is related to the link 74 and second member 62.

As the patient's jaws are opened, the spring 90 urges the first member 54 and the sleeve 88 in opposite directions until such time as the enlarged inner end portion of the sleeve 88 comes into contact with the inner, narrowed end portion of the first member 54 as shown in FIG. 3. Once such contact occurs, further widening of the patient's jaws causes the second member 62 to move away in a direction away from the end cap 56. The second member 62 is freely slidable within the sleeve 88 and is not urged outwardly by the spring 90 independently of movement of the sleeve 88.

Preferably, the overall lengths of the members 54, 62 and the sleeve 88 are selected so that the second member 62 does not entirely withdraw and separate from the sleeve 88 when the patient's jaws are fully opened. The use of three components (i.e., members 54, 62 and sleeve 88) is an advantage in that the second member 62 need not be secured to the sleeve 88, and yet does not separate from the sleeve 88 once installed in the oral cavity. The provision of the three components also facilitates sliding, telescopic movement along a reference axis during use of the force module 40, since a significant section of each component is always in contact with adjacent components. Such overlapping, telescoping contact reduces “cocking” of one of the components relative to adjacent components and as a result excessive frictional binding during sliding movement is avoided.

The link 74 is pivotally movable in an arc relative to the second member 62 in directions about a first axis that is designated by the reference numeral 89 in FIG. 2. The first axis 89 is generally perpendicular to the common reference axis of relative sliding movement between the members 54, 62 and sleeve 88 (which also coincides with the longitudinal axes of the first member 54, the sleeve 88 and the first segment 64 of the second member 62). The first axis 89 extends in a generally occlusal-gingival direction and is perpendicular to the plane of view of FIG. 2. In this embodiment, the first axis 89 coincides with the longitudinal axis of the coupling segment 68, and the link 74 is free to pivot along a 360° arc extending about the first axis 89.

The link 74 is also pivotally movable in an arc relative to the lower archwire 52 in directions about a second axis that is designated by the reference numeral 91 in FIG. 2. The second axis 91 passes through the lower archwire 52, and is spaced from and preferably generally parallel to the first axis 89. In this embodiment, two aspects of the link 74 enable pivotal movement of the link 74 about the second axis 91: first, the resilient characteristics of the elastomeric link 74 enable the strap portion 76 to bend to a limited extent; and second, the wall sections of the strap portion 76 surrounding the passage 87 do not tightly engage the archwire 52, enabling limited pivotal movement due to the clearance provided. The link 74 is pivotally movable in an arc about the second axis 91 that is preferably in the range of about 50° degrees to about 90° degrees, and more preferably is in the range of about 60° degrees to about 80° degrees relative to the lower archwire 52.

The link 74 provides substantial advantages during use in an orthodontic treatment program. The provision of two pivotal axes of movement, namely the first and second axes 89, 91, enhance self-adjustment of the force module 40 to an optimal orientation during opening and closing movements of the patient's jaws. More specifically, the two axes 89, 91 of pivotal movement enable the force module 40 to quickly assume an aligned, parallel orientation that best facilitates free sliding movement of the telescoping members 54, 62 and the sleeve 88 as the patient's jaws are moved toward and away from each other.

Preferably, and in this embodiment, the link 74 is also free to pivot in an arc about the longitudinal axis of the lower archwire 52.

In addition, as the patient's jaws are closed, the two axes 89, 91 of pivotal movement enable the force module 40 to be shifted in a lingual direction and assume an orientation that is closely adjacent the patient's dental arches. This orientation is nearer to the patient's dental arches than would otherwise be possible in comparison to, for example, a force module that is only able to pivot about a single axis such as an axis in the same location as the first axis 89. By moving the force module 40 inwardly in a lingual direction as the patient's jaws are closed, the force module 40 is less likely to impinge against opposing soft tissue in the patient's oral cavity, which might irritate the tissue and cause discomfort.

Although not shown in the drawings, the force module 40 is normally used in pairs. While FIGS. 1 and 2 depict the force module 40 in place along the left side of a patient's oral cavity, a second force module that is similar to force module 40 in mirror image is also typically installed along the right side of the patient's oral cavity. In this manner, a balanced amount of force is presented along both sides of the patient's jaws for repositioning the dental arches as desired.

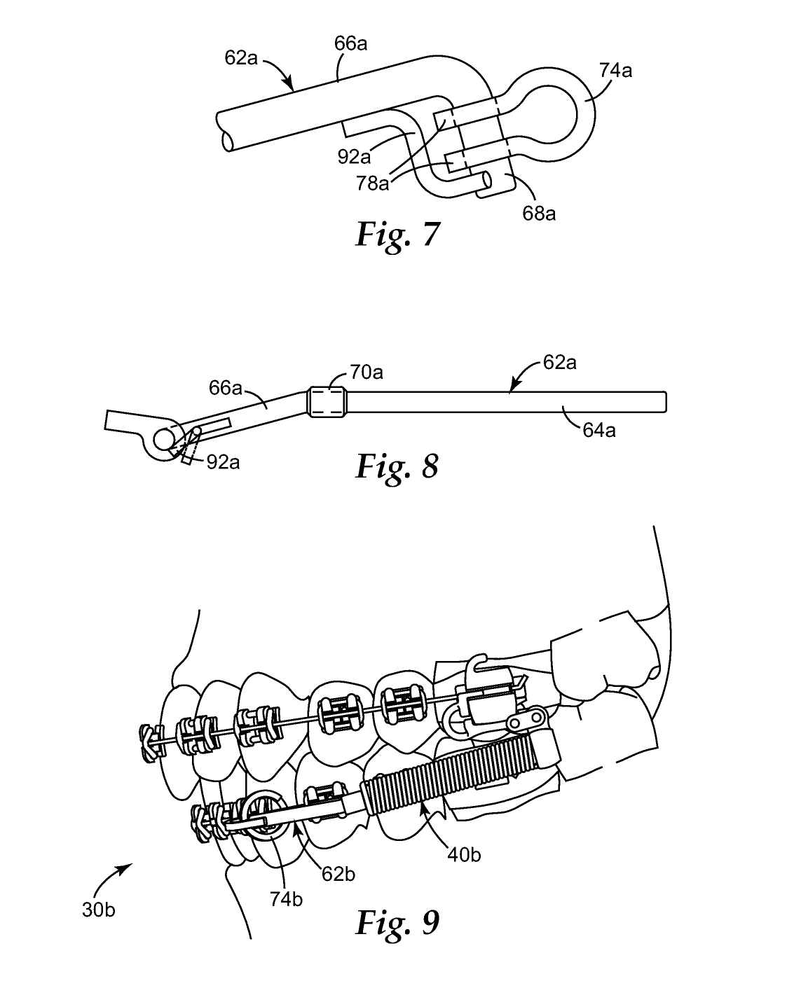

An alternative second member 62a and link 74a according to another embodiment of the invention is illustrated in FIGS. 7 and 8. The second member 62a includes a coupling segment 68a but lacks an enlarged head such as the spherical head 72 illustrated in FIG. 3. In addition, the second member 62a includes a latch 92a comprised of a resilient wire segment having a somewhat overall, generally “S”-shaped configuration. One end of the latch 92a is affixed by a welding or brazing process to a second segment 66a of the second member 62a, and the opposite end of the latch 92a normally bears against a portion of the coupling segment 62a adjacent its outer end. The second member 62a also includes a first segment 64a and a collar 70a that is located between the first segment 64a and the second segment 66a.

The link 74a that is illustrated in FIGS. 7 and 8 comprises a section of formed, malleable metallic sheet material having an overall, generally “U”-shaped configuration. Outer, adjacent ends of the link 74a include two loop portions 78a presenting aligned apertures for receiving the coupling segment 68a. During assembly of the link 74a to the second member 62a, the latch 92a is located in an orientation initially away from the coupling segment 68a as shown by the dashed lines in FIG. 8 in order to enable the loop portions 78a to pass by the latch 92a and be received on the coupling segment 68a. Subsequently, pressure is applied to the latch 92a in order to move the latch 92a to the orientation shown in full lines in FIG. 8 and thereafter retain the link 74a in place.

Other aspects of the second member 62a and the link 74a are similar to the second member 62 and link 74 respectively described above. As such, a detailed description of those aspects need not be repeated. However, as an alternative assembly, the link 74 may be used in place of the link 74a in combination with the second member 62a depicted in FIGS. 7 and 8.

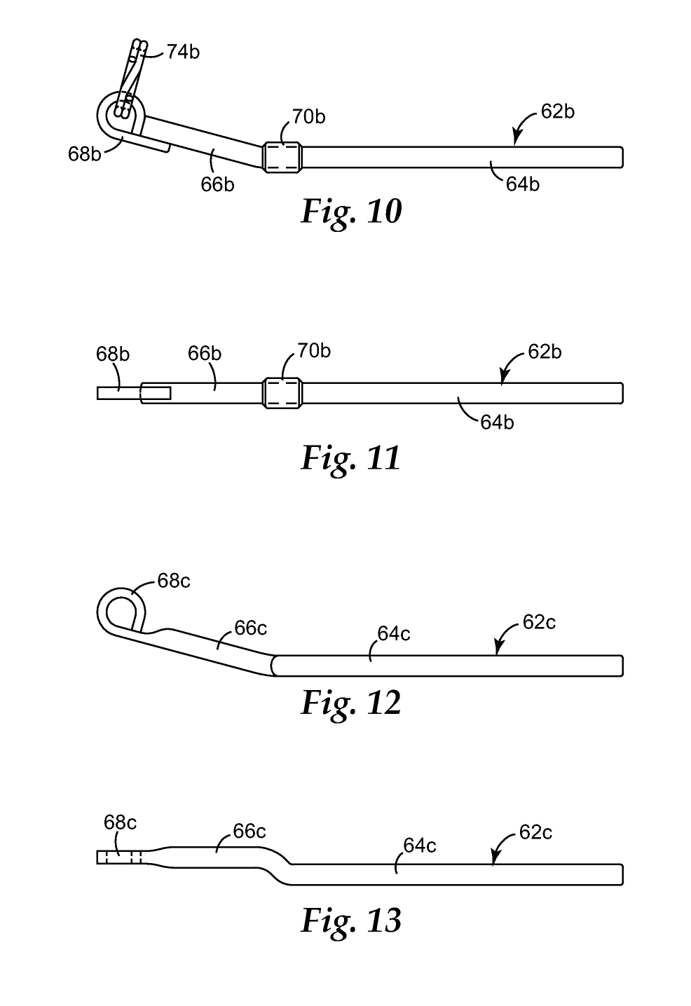

An orthodontic assembly 30b according to another embodiment of the invention is illustrated in FIG. 9 and includes an intra-oral force module 40b for moving the relative positions of the upper and lower dental arches. The force module 40b includes a second member 62b that is also shown in FIGS. 10 and 11, and a link 74b that is shown in FIG. 10 but omitted in FIG. 11.

With reference to FIGS. 10 and 11, the second member 62b includes a first segment 64b, a second segment 66b and a coupling segment 68b. In this embodiment, the first and second segments 64b, 66b are fabricated from a section of wire and bent at an angle that is similar to the angle between the first and second segments 64, 66 of the second member 62 illustrated in FIGS. 1-4. In this embodiment, the coupling segment 68b is fabricated from a second section of rectangular wire that is bent in a loop to form a generally “P”-shaped configuration. The coupling segment 68b is tack welded and then brazed in place for secure connection to the outer end of the second segment 66b. The second member 62b also includes a collar 70b that is brazed and/or welded in place in a location adjacent the junction between the first and second segments 64b, 66b.

The force module 40b also includes a link 74b that in this embodiment comprises a split ring. When the link 74b is assembled to the second member 62b, the link 74b extends through the opening of the coupling segment 68b.

Preferably, the link 74b is assembled to the second member 62b by the manufacturer. Optionally, the manufacturer may place a wedge of material between adjacent helical sections of the split ring link 74b to assist the practitioner in connecting the link 74b to the archwire. In addition, or as an alternative, the practitioner may elect to use a pair of split ring pliers to facilitate installation.

Other aspects of the assembly 30b including the force module 40b are similar to the assembly 30 and force module 40 respectively as described above.

FIGS. 12 and 13 illustrate a second member 62c of a force module according to yet another embodiment of the invention. The second member 62c is fabricated from a single section of wire. One end portion of the second member 62c is swaged down and formed into a loop to provide a coupling segment 68c. The second member 62c is also bent and formed into two distinct segments, namely a first segment 64c and a second segment 66c. An offset bend interconnects the first and second segments 64c, 66c to provide a stop that is similar in function to the collars 70, 70b described above.

The second member 62c can be used in combination with the split ring link 74b shown in FIGS. 9 and 10, or alternatively with any of the links that are described in the paragraphs that follow. Other aspects of the second member 62c are similar to the second members 62, 62a and 62b as set out above.

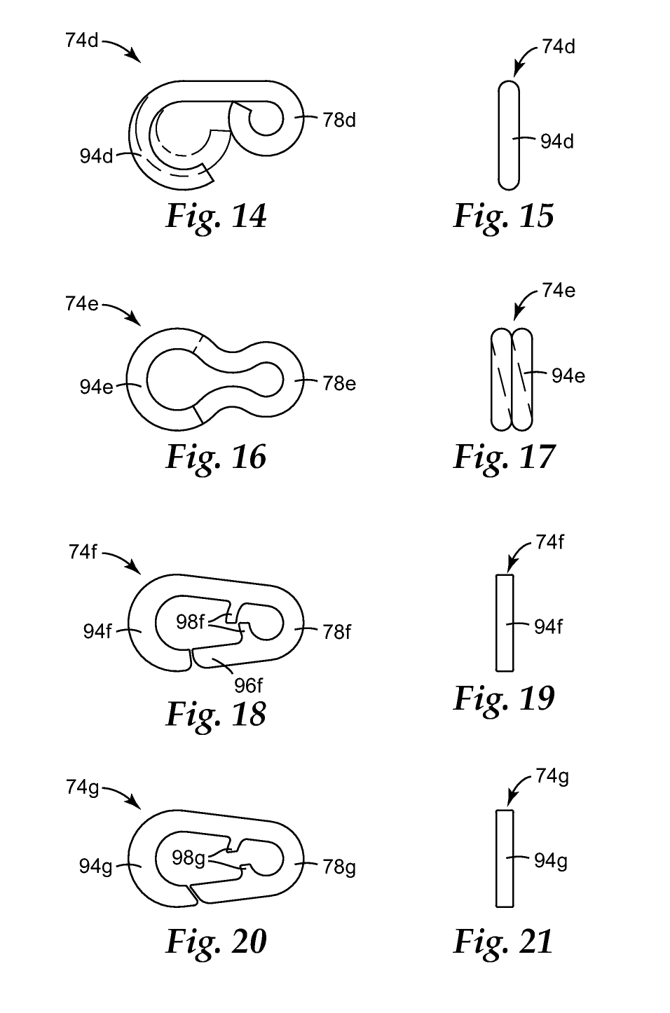

Alternative links are depicted in FIGS. 14-21. In FIGS. 14-15, link 74d is made from a section of wire having malleable characteristics. Optionally, a loop portion 78d of the link 74d is pre-assembled by the manufacturer to a coupling segment of a second member (such as second member 62b or 62c) of a force module. Initially, a coupling portion 94d of the link 74d is left partially opened as indicated by the full lines in FIG. 14. This coupling portion 94d is then pinched shut by the practitioner to a closed position as indicated by the dashed lines in FIG. 14 after placement of the coupling portion around a wire of an orthodontic assembly such as an archwire.

The link 74e that is shown in FIGS. 16 and 17 comprises a resilient split ring having a lanyard-shaped configuration. A loop portion 78e of the link 74e is placed onto a loop of a coupling segment of a second member by the manufacturer. When desired for use, adjacent sections of the split ring link 74e are moved apart from each other to enable placement of a coupling portion 94e of the link 74e around a wire such as an orthodontic archwire, similar to installation of the split ring link 74b shown in FIGS. 9 and 10.

The link 74f depicted in FIGS. 18-19 comprises a snap-action clip that is made from a resilient material such as an alloy or nitinol. The link 74f includes a loop portion 78f that receives a coupling segment of a second force module member. The link 74f also includes a coupling portion 94f for placement around a wire such as an orthodontic archwire.

The link 74f includes a leg 96f that can be moved inwardly upon the application of pressure in order to admit an archwire into the coupling portion 94f Once pressure on the leg 96f is released, the leg 96f returns to its normally closed orientation as shown in FIG. 18. Optionally, the link 74f includes inner prongs 98f that serve to retain the coupling segment of the second member in the loop portion 78f and away from the coupling portion 94f.

The link 74g that is illustrated in FIGS. 20-21 is somewhat similar to the link 74f. However, the link 74g includes prongs 98g that are somewhat shorter than the prongs 98f. As such, the link 74g may be assembled to the coupling segment of the second member with less effort.

All of the patents and patent applications identified above are hereby incorporated by reference. Those skilled in the art may recognize that a number of modifications and additions may be made to the various embodiments described above without departing from the spirit of the invention. For example, the links 74-74g may be used for connection to a wire other than a lower archwire, such as an upper archwire, an auxiliary archwire or a segment of wire that extends in generally parallel relationship to an archwire. Other variations are also possible. Accordingly, this invention should not be deemed limited to the presently preferred embodiments that are set out in detail above, but instead only by a fair scope of the claims that follow along with their equivalents.

1. An orthodontic assembly comprising:
a brace secured to a first dental arch including a set of appliances and a wire connected to the appliances, the wire having a longitudinal axis; and
an intraoral force module including a first member, a second member, a helical compression spring coaxial with the first member and extending eternally around at least one of the first member and the second member, and a connector, the second member being connected to the first member for sliding, telescopic movement relative to the first member in directions along a reference axis, the connector coupling the first member to a second dental arch opposite the first arch, wherein the force module further includes a link closed about the wire and connecting the second member to the wire, wherein the link includes a radially enclosed passage that encloses the wire therein, wherein the link is movable relative to the second member about a first axis that is generally perpendicular to the reference axis and wherein the link, despite being installed on the wire and closed such that the wire cannot be removed in a generally facial direction from the passage, is pivotally movable relative to the wire about both a second, longitudinal axis of the wire and in an arc in the range of 50 degrees to 90 degrees about a third axis passing through the wire and generally parallel to the first axis.

2. An orthodontic assembly according to claim 1 wherein the link comprises an elastomeric material.

3. An orthodontic assembly according to claim 2 wherein the link includes a central strap portion with opposed first and second ends and first and second loop portions connected to the first and second ends respectively, wherein the link further includes an open state and a closed state, and wherein the link in the open states includes first and second tabs extending outwardly from the first and second loop portions respectively in directions away from each other.

4. An orthodontic assembly according to claim 1, wherein the link includes a coupling portion configured to receive the wire and a loop portion configured to receive an outer end portion of the second member.

5. An orthodontic assembly according to claim 4 wherein the loop portion includes at least one aperture for receiving the outer end portion of the second member, and wherein the loop portion is resilient.

6. An orthodontic assembly according to claim 1, wherein the link is pivotally movable in an arc about the second axis in the range of 60 degrees to 80 degrees.

7. An orthodontic assembly according to claim 1 wherein at least some of the appliances include an archwire slot, and wherein the wire comprises an archwire that is received in at least some of the archwire slots.

8. An orthodontic assembly comprising:
a brace secured to a first dental arch including a set of appliances and a wire connected to the appliances, the wire having a longitudinal axis;
a first member including a helical compression spring coaxial with at least a portion of the first member;
a second member, the second member being connected to the first member for sliding movement relative to the first member in directions along a generally mesial-distal reference axis, wherein the second member includes an outer end segment including a bar that extends in a direction generally perpendicular to the reference axis to a spherical head having larger cross-sectional dimensions than the bar; and
a link connecting the second member to the wire and including an enclosed passage enclosing the wire therein such that the wire cannot be removed in a generally facial direction from the passage, the link being pivotally moveable relative to the wire both in an arc about the longitudinal axis of the wire and in an arc about a second axis perpendicular to with the mesial-distal reference axis, wherein the link includes at least one aperture oriented generally perpendicular to the passage for receiving the outer end segment, and wherein the aperture presents an interference fit with the spherical head.

9. The orthodontic assembly of claim 8, wherein the link is comprised of an elastomeric material having a modulus of elasticity that is sufficient to enable the aperture to be enlarged and allow passage of the head through the aperture to retain the bar in the aperture.

10. The orthodontic assembly of claim 8, wherein the link includes a central strap portion with opposed first and second ends and first and second loop portions connected to the first and second ends respectively.

11. The orthodontic assembly of claim 8, wherein the link further includes an open state and a close state, and wherein the link in the open state includes first and second tabs extending outwardly from the first and second loop portions respectively in directions away from each other.

12. The orthodontic assembly of claim 8, wherein the link includes a coupling portion including the passage and a loop portion including the at least one aperture to receive the outer end segment portion of the second member.

13. The orthodontic assembly of claim 8, wherein the link is movable in an arc in the range of 50 degrees to 90 degrees about a third axis passing through the wire and generally parallel to the first axis.

14. An orthodontic assembly according to claim 13, wherein the link is pivotally movable in an arc about the second axis in the range of 60 degrees to 80 degrees.

15. An orthodontic assembly according to claim 8, wherein at least some of the appliances include an archwire slot, and wherein the wire comprises an archwire that is received in at least some of the archwire slots.
